(19) United States
(12) Patent Application Publication
(10) Pub. No.: US 2008/0264447 A1
(43) Pub. Date: Oct. 30, 2008

(54) Self-Cleaning Chlorine Generator with Intelligent Control

(76) Inventor: Omer C. Eyal, Altamonte Springs, FL (US)

Correspondence Address: SMITH HOPEN, PA, 180 PINE AVENUE NORTH, OLDSMAR, FL, 34677, US

(21) Appl. No.: 11/850,202

(22) Filed: Sep. 5, 2007

Related U.S. Application Data
(63) Continuation-in-part of application No. 10/711,419, filed on Sep. 17, 2004.

(51) Int. Cl. B08B 3/08; C25B 9/00

(52) U.S. Cl. 134/18; 204/229.4

(57) ABSTRACT

A water treatment system includes a circulation pump and a chlorine-generating electrolytic cell in fluid communication with a main body of water. When mineral deposits foul the generator, water is stagnated within the electrolytic cell and a minimal amount of a pH-reducing agent is added to remove the mineral deposits. The pH-reducing agent is admitted on a periodic timed basis or when the pH of the main body of water exceeds a predetermined threshold. Cleaning is accomplished by adding the pH-reducing agent when water in the electrolytic cell is not circulating so that the acid dwells within the electrolytic cell for a sufficient amount of time. Re-activation of circulation through the electrolytic cell causes the pH-reducing agent to enter the main body of water.

### CROSS-REFERENCE TO RELATED DISCLOSURES

This disclosure is a continuation-in-part of U.S. patent application Ser. No. 10/711,419, entitled Self-Cleaning Chlorine Generator With pH Control, filed Sep. 17, 2004, by the present inventor. That disclosure is hereby incorporated by reference in its entirety into this disclosure.

### BACKGROUND OF THE INVENTION

1. Field of the Invention

This invention relates to electrolytic chlorine generators. More particularly, it relates to method for introducing a pH-reducing agent into an electrolytic cell for dissolving mineral deposits from electrolytic plates.

2. Description of the Prior Art

Electrolytic chlorine generators include electrolytic cells having plates that are coated on one side or both sides, depending upon the type of cell, with a platinum group metal (PGM) such as ruthenium, or similar coating.

The operation of an electrolytic chlorine generator has the side effect of gradually increasing the pH level of a body of water undergoing such chlorination. If the pH is too high, it can adversely affect the water quality and the effectiveness of the chlorine generated by the generator. Accordingly, the pH level of a swimming pool, spa, fountain, well, or other body of water equipped with an electrolytic chlorine generator and a circulating pump must be lowered periodically.

A pool, spa, fountain, well owner, or the like is required to periodically perform a test of the water to determine its pH level, and to add muriatic acid or other suitable pH-reducing agent to reduce the level if it is too high. The acid has a pH of about 0.1 and thus is extremely dangerous to handle and causes severe burns if it contacts the skin, open wounds, or the eyes.

There is therefore a need for an improved method for adjusting the pH of water in circulating water systems equipped with an electrolytic chlorine generator. More particularly, there is a need for a method that reduces the frequency with which such pH-reducing agents must be handled.

Moreover, the electrolytic cells that generate the chlorine are subject to degradation due to the formation of mineral deposits, typically calcium, thereon. The mineral deposits must therefore be removed as needed.

One prior art technique for cleaning the cells requires manually removing them from the chlorination system and soaking them in acid. In a typical swimming pool system, such manual cleaning is required about every two weeks. Such manual cleaning is burdensome, risky, and has the disadvantage of using excessive amounts of acid. The electrolytic cell or block of plates is removed from the circulation line and soaked for approximately five (5) minutes in a bucket containing a diluted hydrochloric acid solution of about one (1) part acid to five (5) parts water.

The frequency of manual cleaning may be reduced to quarterly if the polarity of the electric charge transmitted to the electrolytic plates is periodically reversed. Chlorine is produced on the anode plate or the anode side of a bipolar cell. Thus, in an ideal electrolytic cell, a PGM is applied only to the anode plate or the anode side of a bipolar cell. The cathode plate, or the cathode side of a bipolar cell, is not coated because such plate or side is merely needed to complete the electrical circuit.

However, in a practical electrolytic cell, the cathode plate and the cathode side of plates in a bipolar cell must also be coated because the polarity of the anode and cathode must be reversed periodically to clean the plates. More particularly, a system that requires polarity reversal is typically operated half the time in one polarity and half the time in the opposite polarity. A system that does not rely on reverse-polarity operation would thus reduce the amount of PGM-coated plates by half.

Unfortunately, reversing polarity has detrimental effects on the electrolytic plates. A PGM coating holds up well during anode operation, but steadily deteriorates during cathode operation. Thus it is desirable to operate PGM-coated plates only on the anode side and the uncoated plates only on the cathode side. Reversal of polarity results in cathode operation of the PGM coated side. Accordingly, cleaning of deposits from the plates by reversing the polarity of the anode and cathode should be minimized if not completely avoided. However, most electrolytic chlorine generators rely on polarity reversal as the primary means of removing calcium deposits from the plates.

Unfortunately, polarity reversal causes the plates to repeatedly charge up, and such charging up wears out the PGM coating at a much faster rate than steady state operation.

More specifically, charging the plates causes the plates to absorb a minor shock that wears out the PGM coating. This shock can be minimized by a gradual discharging of the plates, followed by a gradual re-charging at an opposite polarity. This method of reversing polarity is called the “soft start” method and reduces but does not eliminate wear on the plates. Thus it is beneficial to eliminate or to at least reduce the number of times that the system is subjected to a reverse polarity, and to use the soft start method when a polarity reversal is required.

However, even with routine reversal of polarity, the electrolytic cells will still collect calcium deposits over time. At least some of the calcium deposits will eventually flake off and foul the body of water. In a swimming pool or spa, this unsightly debris is eventually suctioned by a pool cleaner or pool drain into a pool filter where the calcium is collected.

A need therefore exists for a method that will clean calcium deposits from electrolytic plates before the calcium flakes off from the plates.

Hardened calcium deposits do not easily dissolve back into the body of water so they remain on the filter until it is removed from the system and cleaned. The calcium content of the water thus drops over time and requires replenishment because low-calcium water will aggressively attack various pool walls and equipment.

Thus there is a need for an electrolytic chlorine generator that cleans calcium deposits from electrolytic plates but which does not result in removal of calcium from the body of water, and which therefore does not require that calcium be added periodically to a body of water.

Electrolytic chlorinators operate best when the salt content of the main body of water is between 2800 to 5000 parts per million. This high salinity adversely affects some swimmers if the main body of water is a swimming pool. Such high salinity may disqualify an electrolytic chlorinator from use where the main body of water is a fountain because salt may leave white marks on fixtures after a fixture has been splashed and the splashed water has evaporated.

A need therefore exists for an electrolytic chlorinator that operates well in a low salt environment.

It is known that the salt content of the water may be reduced if the surface area of the PGM-coated plates in the electrolytic cell is exponentially increased and the plates are spaced closer together to compensate for the lower conductivity of the water. Unfortunately, plates that are spaced close to one another become fouled with mineral deposits at a substantially faster rate than more widely spaced plates. This effect may be countered to some extent by increasing the flow rate of water past the plates and by reversing the polarity of the plates on a more frequent basis. Since maintaining higher flow rates often requires increased energy and equipment expenditures and the increased use of polarity reversal wastes the PGM, most systems forego the closer plate spacing and continue to require high salinity.

Thus there is a need for an electrolytic chlorinator that operates well at lower salt levels without requiring a higher flow rate and without increasing the consumption of PGM.

A general need exists for an improved method for cleaning calcium and other mineral deposits from the electrolytic cells of an electrolytic chlorine generator. The improved method would not have a detrimental effect on the electrolytic plates and would eliminate the need for biweekly or quarterly manual cleaning of the cells.

The improved method would also eliminate or at least substantially reduce the need for cleaning the plates by subjecting them to polarity reversal. Such an improved method would thus lower the requisite number of PGM-coated plates.

However, in view of the prior art taken as a whole at the time the present invention was made, it was not obvious to those of ordinary skill how the identified needs could be fulfilled.

### SUMMARY OF THE INVENTION

The long-standing but heretofore unfulfilled need for an improved means for adjusting the pH of water having chlorine added thereto by an electrolytic chlorine generator and for cleaning calcium or other mineral deposits from the electrolytic cells of such generator is now met by a new, useful, and non-obvious invention.

In its simplest form, the inventive structure is a novel chlorine generator that uses the natural propensity of electrolytic chlorination to increase pH levels over time as a means to enable the cleansing of an electrolytic cell by introducing a predetermined volume of a pH-reducing agent into the electrolytic cell so that mineral deposits are dissolved from cell plates during a time period that a circulation system is not operating, e.g., during an overnight time period. Advantageously, the novel system controls pH levels in the body of water as well. After the circulation pump is turned off so that water is not circulating through the system, a minimal amount of water is automatically isolated within an electrolytic cell and a predetermined minimal volume of hydrochloric acid or other suitable pH-reducing agent is automatically introduced into the electrolytic cell using an acid pump. The pH level in the isolated cell is significantly reduced because the finite body of water affected by the pH-reducing agent is relatively small. The low pH solution dwells within the electrolytic cell overnight or for the duration of the cycle downtime if the system is not circulating at some other time of day. The lowered pH solution has a small but consistent and persistent effect on calcium build-up on the plates of the electrolytic cell, gradually dissolving the calcium and having a limited, controlled effect on the pH and alkalinity levels in the main body of water.

In a more advanced embodiment, an electrolytic cell may be cleaned when the circulation pump is operating. This is accomplished by providing two electrolytic cells in parallel relation to one another and providing motor-operated actuators for selectively opening and closing their inlets and outlets as needed to allow water flow through one of the cells while closing the other cell so that water is stagnant within it. Acid is then infused into the stagnant cell to clean it while the rest of the system remains in normal operation. Alternatively, a single cell may be provided with a bypass line so that the system can continue to operate while the cell is isolated.

The acid pump is not needed if an acid reservoir is positioned above the cell so that the cell is gravity-fed. For this reason, the term acid infusion means is used herein to indicate a pump when the acid reservoir is not elevated with respect to the cell and to indicate a gravity-fed system when the reservoir is elevated with respect to the cell.

A very small amount of pH-reducing agent is required to automatically clean the cell because the volume of water in the cell is minimized. Less water enables the use of less pH-reducing chemical. Accordingly, the quantity of pH-reducing agent is minimized by isolating the smallest possible amount of water within and around the electrolytic cell. The volume of water isolated within and around the cell determines the amount of acid necessary to effectively reduce the pH levels and thereby clean the cell.

The novel chlorine generator of this disclosure introduces a predetermined volume of hydrochloric acid, commercially known as muriatic acid, or an alternative pH-reducing agent into an electrolytic cell to dissolve mineral deposits from cells during times when the water is stagnated inside the electrolytic cell, such as when the circulation pump is not operating. Water may also be stagnated inside the electrolytic cell when the circulation pump is operating in those installations that provide a bypass around the electrolytic cell.

A predetermined volume of a pH-reducing agent such as muriatic acid may be introduced into the electrolytic cell on a predetermined, periodic schedule. The pH-reducing agent may also be added in response to monitored levels of pH in the main body of water.

The pH-reducing agent is introduced into the electrolytic cell when the water inside the electrolytic cell is stagnant. The pH-reducing agent resident in the electrolytic cell, after having been used to clean mineral deposits from the electrolytic cells over an extended period of time, is flushed into the main body of water, thereby reducing the pH level in the main body of water, when water circulation through the electrolytic cell is re-activated.

Significantly, the volume of water within the electrolytic cell is small. Thus, only a small amount of pH-reducing agent is required to substantially lower the pH of the water in the electrolytic cell and to thereby cause removal of calcium deposits. Thus, when the circulation pump is re-started, only a small amount of pH-reduced water is introduced into the swimming pool or other main body of water under treatment. This prevents abrupt drops in the pH level of the body of water as a whole. Advantageously, the small injections of reduced pH water into the main body of water serve to maintain the pH within the desirable range.

Accordingly, the electrolytic cells or plates are not removed from the electrolytic cell prior to their cleaning by the muriatic acid. This advantageously saves the time expended in manually removing the electrolytic plates, cleaning them, and re-installing them. It also avoids wasteful use of the pH-reducing agent.

The same pump mechanism that is used to infuse the acid solution into the cell may also be operated to further reduce pH levels within the main body of water by infusing the acid solution while the main circulation pump is operating. This may be used in combination with the standard operation of the present invention when the acid demand of the main body of water is greater than the acid necessary to clean the cell.

Various pumps or gravity-based mechanisms may be used to infuse the acid into the electrolytic cell.

An algorithm is used to determine how much acid should be diffused into the cell during circulation pump operation and how much should be infused in the cell for cleaning purposes. It is critical that the acid diffused during circulation pump operation does not excessively reduce the pH level and thus prohibit the infusion of acid into the cell for cleaning purposes.

For twenty four (24) hour run cycles and commercial applications, each cell may be isolated for the cleaning process using bypass piping and three-way valves having motorized actuators or by other similar means. This enables the circulation pump to circulate water through the bypass while the cell cleaning process is underway.

The electrolytic cell is vertically or horizontally oriented and a check valve, Hartford loop, 3-way valve, or other water entrapment means prevents water from flowing from the cell to the main body of water when the circulation pump is off.

In all embodiments, the pH-reducing agent is preferably muriatic acid and the infusion means is preferably a peristaltic pump. Any other suitable pH-reducing agent and any other actuator means, such as a solenoid valve, is within the scope of this invention.

The frequency of cleanings depends upon the condition of the water. The time required to dissolve the acid has been found to be approximately sixty (60) minutes in most cases. More time is needed if there is an excessive amount of mineral buildup in the cell.

An important object of the invention is to provide an improved method for adjusting the pH of water in circulating water systems equipped with an electrolytic chlorine generator.

Another important object is to provide a method for cleaning the plates of an electrolytic chlorine generator.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWING

For a fuller understanding of the nature and objects of the invention, reference should be made to the following detailed description, taken in connection with the accompanying drawing, in which:

FIG. 1 is a diagrammatic view of the invention;

FIG. 2A is a diagrammatic view of a cell in parallel relation to a bypass pipe;

FIG. 2B is a diagrammatic view of a pair of cells in parallel relation to one another and a first configuration of actuators;

FIG. 2C is a diagrammatic view of a pair of cells in parallel relation to one another and a second configuration of actuators; and

FIG. 2B is a diagrammatic view of a pair of cells in parallel relation to one another and a third configuration of actuators.

### DETAILED DESCRIPTION OF THE PREFERRED EMBODIMENT

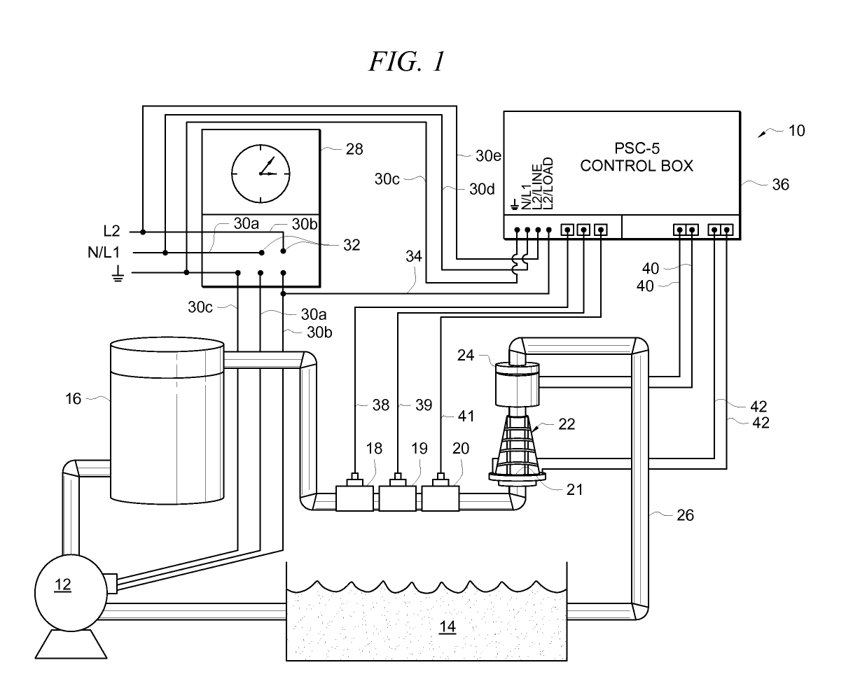

Referring now to the FIG. 1, it will there be seen that an illustrative embodiment of the invention is denoted as a whole by the reference numeral 10.

Circulation pump 12 draws water from swimming pool 14, or spa, fountain, well, or other main body of water, not shown, and pumps said water through filter 16, pH probe 18, ORP (oxidation reduction potential) probe 19, flow sensor 20, one-way check valve or other water-entrapment means 21 (such as a three-way valve with motor-operated actuators or a Hartford loop), electrolytic cell 22, also referred to herein as the cell, acid pump 24, also referred to herein as an acid infusion means, and into pool 14 through return line 26.

The preferred water-entrapment means 21 in the embodiment of FIG. 1 is a Hartford loop, also known as an S-loop. If a one-way check valve is used, the pressure of the water is sufficient to open it.

In installations lacking a cell isolation/bypass structure, such as the installation of FIG. 1, it is important that circulation pump 12 does not operate during a cell cleaning cycle because acid infused into cell 22 must dwell within the cell for an effective period of time. It is also important that circulation pump 12 does not activate as soon as a cell cleaning cycle is completed, i.e., said pump should remain “off” during the cell cleaning process and for a predetermined length of time thereafter.

Circulation pump 12 is under the control of timer 28. It is commercially available from Intermatic, but timers from other sources will also suffice. See, for example, http://www.intermatic.com.

Line power is provided to timer 28 and to circulation pump 12 by electrical conductors 30a, 30b. A double pole single throw (DPST) switch 32 is in series with said electrical conductors and is controlled by timer 28. The ground wire is denoted 30c.

To optimize the cell cleaning process, an intelligent control means is advantageously employed to record the operating hours of circulation pump 12 and to thereby learn the operating schedule of said pump. Continuous line power is delivered to power supply/intelligent control means 36 by electrical conductors 30d, 30e which are connected to conductors 30a, 30b, respectively, upstream of DPST switch 32.

Electrical conductor 34 provides electrical communication between the load side of timer 28 and intelligent control means 36. Control means 36 includes a printed circuit board having logic circuitry. The circuitry is not illustrated, but those of ordinary skill in the art of logic circuitry can make and use the present invention upon observing the operation of said control means as disclosed herein. Control means 36 uses an algorithm to determine the ideal times for initiating cell cleanings and pH reductions. Said control means also determines the respective amounts of pH-reducing agent to be used for each cell cleaning.

pH probe 18 is electrically connected to intelligent control means 36 by conductor 38.

ORP probe 19 is electrically connected to intelligent control means 36 by conductor 39. ORP probe 19 is a sensor that measures the oxidation reduction potential of whatever oxidizer may be in the water, such as chlorine. The ORP probe gives a rough estimation of the chlorine level, but also takes into consideration the effect of various other factors on the oxidizer's ability to oxidize noxious particles. These other factors include the pH level (higher pH reduces the efficacy of chlorine), stabilizer levels (cyanuric acid), and so on.

The opening and closing of flow sensor 20 is monitored by control means 36 through electrical conductor 41.

Operation of acid pump 24 is controlled by control means 36 through electrical conductors 40. However, when an acid reservoir is positioned above the cell, no pump is needed because the force of gravity is sufficient to cause the desired infusion of acid into the cell when water is not circulating therethrough.

By electrically connecting power supply/control means 36 to continuous power and electrically connecting the load side of timer 28 to said control means, which has a tracking memory, said control means is operative to record the operating hours of circulation pump 12 and learn the operating schedule of said circulation pump. Power is thus supplied to power supply/intelligent control means 36 twenty four hours per day (24 hr/day) by said conductors 30d, 30e. Electrical conductor 34 enables said power supply/control means 36 to detect whether circulation pump 12 is operating (DPST switch 32 closed) or inactive (DPST switch 32 open).

The monitoring feature can also be accomplished via a battery backup. Power supply/control means 36 operates on a battery backup during the time that circulation pump 12 is operating. Batteries degrade quickly or break in outdoor heat and therefore are an expensive option.

When circulation pump 12 is operating, control means 36 deactivates acid pump 24 by sending a “shut down” signal through conductors 40 and activates chlorine-generating cell 22 by charging the plates through conductors 42.

When timer 28 opens DPST switch 32, thereby deactivating circulation pump 12, control means 36 detects the absence of load through conductor 34 and sends a “start” signal to acid pump 24 through conductors 40 for a predetermined period of time to ensure that an effective amount of acid is infused into the cell. The effective amount of acid is predetermined in laboratory tests, and varies with the size of the cell, the hardness of the water, and several other parameters. A minimal amount of acid is used to minimize damage to the blades of the cell. If the cell is gravity-fed, a solenoid valve or the like is used to stop the flow of acid into the cell.

Timer 28 is adapted to turn off circulation pump 12 at predetermined times for a predetermined length of time. Control means 36 ensures that circulation pump 12 remains “off” during a cell cleaning cycle and for a predetermined amount of time thereafter.

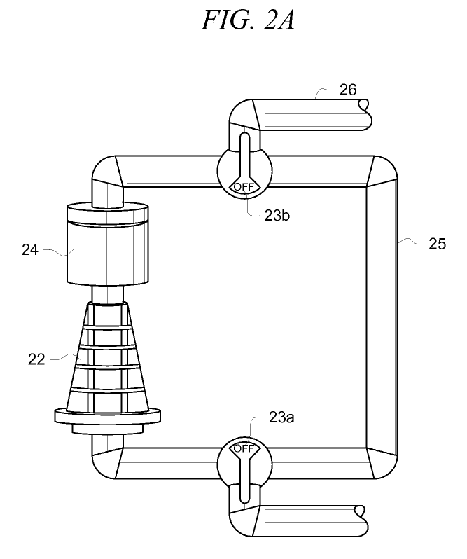

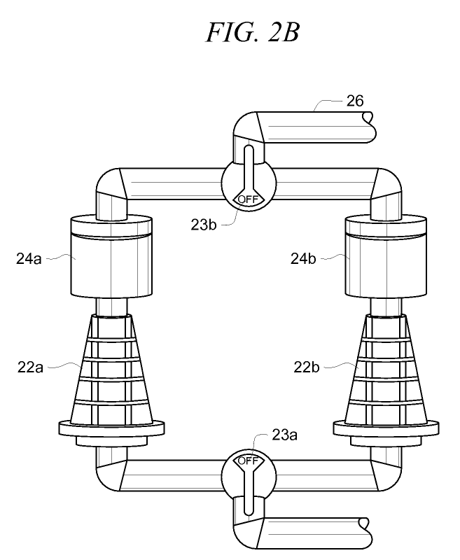

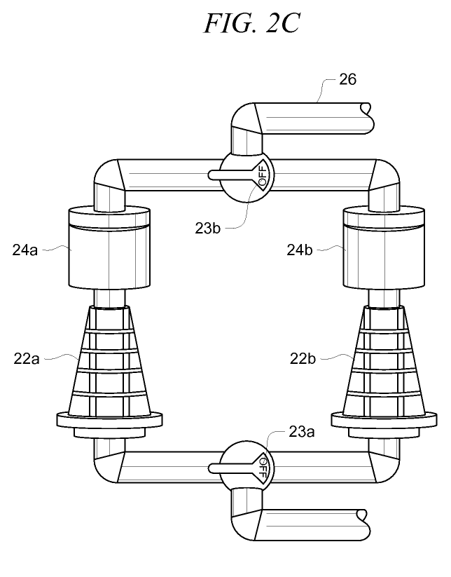

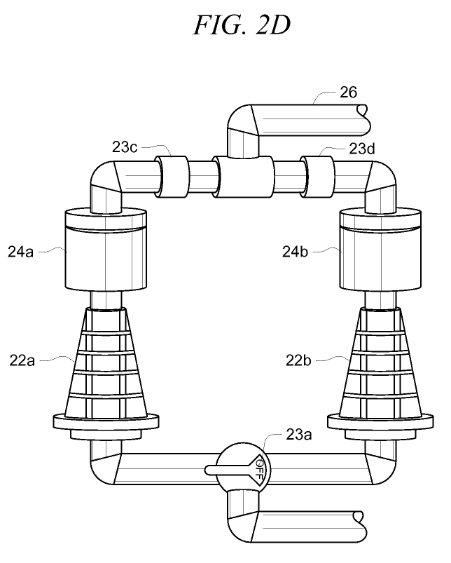

There may be a need for a cell cleaning when circulation pump 12 is in operation. This may be accomplished by the structures depicted in FIGS. 2A-D.

In FIG. 2A, cell 22 is bypassed by piping 25. In this particular depicted configuration of actuators 23a, 23b, water is flowing through cell 22 as well as through bypass piping 25. Rotation of actuator 23a ninety degrees (90°) counterclockwise is the cell-inlet-closed, bypass-inlet-open position and rotation of actuator 23b ninety degrees (90°) clockwise is the cell-outlet-closed, bypass-outlet-open position which isolates cell 22 so that the water therewithin is stagnant. Circulation pump 12 may continue to operate because said configuration of actuators enables water to flow through said bypass piping.

In FIG. 2B, circulating water flows through cells 22a, 22b without restriction because motor-driven actuator 23a is in a position that opens both inlet valves and motor-driven actuator 23b is in a position that opens both outlet valves.

In FIG. 2C, actuator 23a is in a position that opens the inlet valve of cell 22a and closes the inlet valve of cell 22b. Actuator 23b is in a position that opens the outlet valve of cell 22a and closes the outlet valve of cell 22b. This isolates cell 22b for cleaning while the water in the rest of the system continues to circulate along a path of travel that includes cell 22a.

In the embodiment of FIG. 2D, actuator 23b is eliminated and one-way check valves 23c and 23d are positioned in the outlet lines of cells 22a, 22b, respectively. Cell 22b is isolated for cleaning by positioning actuator 23a in opening relation to the inlet of cell 22a and closing relation to the inlet of cell 22b. One-way check valve 23c thus allows water to flow through cell 22a and one-way check valve 23d prevents water flowing through valve 23c from entering said valve 23d, thereby isolating cell 22b.

The embedded algorithm determines the appropriate amount of acid to be infused during circulation while keeping enough acid demand in the body of water to warrant the infusion of a pH reducing agent for a cleaning cycle at the appropriate time without reducing the pH level of the main body of water below a predetermined threshold.

In this way, intelligent control means 36 uses the runtime schedule of circulation pump 12 to determine when to start and stop the cell-cleaning process.

The invention may also be understood to include the method steps performed by the apparatus disclosed herein. However, it should be understood that different apparatus may be used to perform the method steps, i.e., the invention is not limited to the specific apparatus and structure disclosed herein but is more broadly defined as a method of cleaning a chlorine generator.

More particularly, the steps of the novel method include providing a timer for starting and stopping a circulation pump, electrically connecting a power supply and intelligent control means to line power on a continuous basis, electrically connecting a load side of said timer to said power supply and control means so that said power supply and control means detects when said circulation pump is operating or not operating, providing said power supply and control means with logic circuitry so that the power supply and control means monitors the operating schedule of the circulation pump, providing an electrolytic cell having an inlet and an outlet, pumping water from a main body of water through the electrolytic cell, positioning electrodes within the electrolytic cell, positioning an acid infusion means containing a pH-reducing agent in selective fluid communication with the electrolytic cell, controlling the flow rate of the pH-reducing agent from the acid infusion means into the electrolytic cell so that the pH-reducing agent flows into the electrolytic cell to clean mineral deposits from the electrolytic cell when water within the cell is stagnant, and preventing flow of the pH-reducing agent into the electrolytic cell when water is flowing through said cell.

If timer 28 and intelligent control means 36 are combined into one, operation times of circulation pump 12 are then tracked with software instead of hardware, i.e., conductor 34 would be eliminated.

The acid infusion means may be used to infuse a pH-reducing solution during normal circulation pump operation using the above-disclosed parallel cells or bypass pipe arrangements.

This method enables the system to operate properly without excessive reduction in pH in the main body of water. The critical aspects of the novel method include the provision of isolated water in a small cell and a long dwell time so that a small amount of pH-reducing agent in said small cell can dissolve deposits accumulated on the electrolytic plates.

The method steps further include positioning a Hartford loop, a normally closed manual check valve or a normally open valve between a circulation pump and an electrolytic cell, adapting a valve actuator to open and close the normally open valve, generating and sending a “close” signal to the valve actuator when the circulating pump is not operating, and sending a “start” signal to the acid pump to release a pH-reducing agent from the acid pump into the electrolytic cell for a specific period of time based upon several factors.

The novel method further includes the steps of positioning a flow switch having a flow-sensing means between the circulation pump and the electrolytic cell as a redundant safety means to ensure that water does not flow through the electrolytic cell when said cell is in its cleaning mode and that the electrolytic cell does not operate without proper flow.

The intelligent control means, using a pH sensing device and an algorithm, infuses a pH-reducing agent into the line during circulating pump operation to maintain the pH of the main body of water. It also infuses acid during pump downtime (or during circulation where a cell is bypassed) in sufficient amounts to clean the cell.

The method steps are performed during extended “off” periods of the circulation pump or during circulation pump operation while a cell is isolated to enable cleaning without overcompensation of pH levels. The acid amount is calibrated depending on the size of the pool or other main body of water and the pH readings.

The method includes the steps of mounting the acid infusion point at a preselected elevation above the electrolytic cell so that pH-reducing agent, which is heavier than water, flows downward from the infusion point into the electrolytic cell under influence of gravity when water is stagnant within the cell.

It will thus be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A self-cleaning chlorine generator that forms a part of a circulation system for water in a main body of water, comprising:
at least one electrolytic cell;
said at least one electrolytic cell having an inlet and an outlet;
a means for allowing water entrapment in said electrolytic cell;
a circulation pump adapted to pump water from a main body of water to said inlet and through said at least one electrolytic cell;
said outlet of said at least one electrolytic cell being in fluid communication with a return line that returns water to said main body of water;
an acid infusion means adapted to infuse a pH-reducing agent disposed in selective fluid communication with said at least one electrolytic cell;
a timer in electrical communication with said circulation pump, said timer adapted to start and stop said circulation pump at predetermined times;
a control means in continuous, substantially uninterrupted electrical communication with line power so that said control means is adapted to start and stop operation of said chlorine generator;
an electrical conductor providing electrical communication between a load side of said timer and said control means; and
said control means including logic means that tracks and learns an operating schedule of said circulation pump.

2. The self-cleaning chlorine generator of claim 1, further comprising:
said means for allowing water entrapment selected from a group consisting of a check-valve, a Hartford loop, and a three-way valve with actuators.

3. The self-cleaning chlorine generator of claim 1, further comprising:
an oxidation reduction potential probe disposed in fluid communication with a pressure side of said circulation pump and said inlet of said electrolytic cell;
said control means adapted to receive oxidation reduction potential information from said oxidation reduction potential probe and to adjust the amount of chlorine generated by said electrolytic cell when the circulation pump is operating.

4. The self-cleaning chlorine generator of claim 1, further comprising:
a pH probe disposed in fluid communication with a pressure side of said circulation pump and said inlet of said electrolytic cell;
said control means adapted to receive pH information from said pH probe and to adjust the amount of pH-reducing agent introduced by said acid infusion means into said electrolytic cell when water in the electrolytic cell is stagnant.

5. The self-cleaning chlorine generator of claim 1, further comprising:
a bypass pipe disposed in parallel, bypassing relation to said at least one electrolytic cell;
said inlet of said at least one electrolytic cell having an actuator-controlled three-way valve having a first neutral position where water flows through said at least one electrolytic cell and through said bypass pipe, a second cell-inlet-closed position where water flows through said bypass pipe but not through said electrolytic cell, and a third bypass-inlet-closed position where water flows through said electrolytic cell but not through said bypass pipe; and
said outlet of said at least one electrolytic cell having an actuator-controlled three-way valve having a first neutral position where water flows through said at least one electrolytic cell and through said bypass pipe, a second cell-outlet-closed position where water flows through said bypass pipe but not through said electrolytic cell, and a third bypass-outlet-closed position where water flows through said electrolytic cell but not through said bypass pipe.

6. The self-cleaning chlorine generator of claim 1, further comprising:
said at least one electrolytic cell including a first electrolytic cell disposed in parallel relation to a second electrolytic cell;
a first, inlet-positioned actuator-controlled three-way valve having a first neutral position where water flows into an inlet of said first and second electrolytic cells;
said first actuator-controlled three-way valve having a second position where water flows into an inlet of said first electrolytic cell and not into an inlet of said second electrolytic cell;
said first actuator-controlled three-way valve having a third position where water does not flow into said inlet of said first electrolytic cell and does flow into said inlet of said second electrolytic cell;
a second, outlet-positioned actuator-controlled three-way valve having a first neutral position where water flows from an outlet of said first and second electrolytic cells;
said second actuator-controlled three-way valve having a second position where water flows from an outlet of said first electrolytic cell and not from an outlet of said second electrolytic cell;
said second actuator-controlled three-way valve having a third position where water does not flow from said outlet of said first electrolytic cell and does flow from said outlet of said second electrolytic cell.

7. The self-cleaning chlorine generator of claim 1, further comprising:
said at least one electrolytic cell including a first electrolytic cell disposed in parallel relation to a second electrolytic cell;
a first, inlet-positioned actuator-controlled three-way valve having a first neutral position where water flows into an inlet of said first and second electrolytic cells;
said first actuator-controlled three-way valve having a second position where water flows into an inlet of said first electrolytic cell and not into an inlet of said second electrolytic cell;
said first actuator-controlled three-way valve having a third position where water does not flow into said inlet of said first electrolytic cell and does flow into said inlet of said second electrolytic cell;
a first one-way valve disposed in an outlet of said first electrolytic cell; and
a second one-way valve disposed in an outlet of said second electrolytic cell;
whereby when said first, inlet-positioned actuator-controlled three-way valve is in said first neutral position, water flows from said outlets of said first and second electrolytic cells;
whereby when said first actuator-controlled three-way valve is in said second position, water flows from the outlet of said first electrolytic cell and not from the outlet of said second electrolytic cell;
whereby when said first actuator-controlled three-way valve is in said third position water does not flow from said outlet of said first electrolytic cell and does flow from said outlet of said second electrolytic cell.

8. A method of cleaning a chlorine generator, comprising the steps of:
providing an electrolytic cell with an inlet and an outlet;
entrapping water in said electrolytic cell when water circulation is stopped;
circulating water from a main body of water into said inlet, through said electrolytic cell, out of said outlet, and back to said main body of water;
disposing an acid infusion means in selective fluid communication with said electrolytic cell;
positioning a timer in electrical communication with said circulation pump;
said timer being operative to turn said circulation pump on and off at predetermined times; and
said timer being operative to turn said acid infusion means on and off at predetermined times.

9. The method of claim 8, further comprising the step of:
positioning a flow switch in fluid communication with said circulation pump and said electrolytic cell;
adapting said intelligent control means to monitor the “open” or “closed” signals from said flow switch when said circulation pump is operating.

10. The method of claim 8, further comprising the step of:
providing an algorithm that determines optimal times for initiating cell cleanings and pH reductions; and
incorporating said algorithm into said logic circuitry of said intelligent control means.

11. The method of claim 8, further comprising the steps of:
providing an “s” loop in fluid communication with said inlet for installations having no siphoning effect that drains water from the lines;
whereby partial isolation of said water is adequate in such installations because said acid is heavier than water so that drops of the pH-reducing agent may be gravity fed into the electrolytic cell.

12. A self-cleaning chlorine generator that forms a part of a circulation system for water in a main body of water, comprising:
at least one electrolytic cell;
said at least one electrolytic cell having an inlet and an outlet;
a means for allowing water entrapment in said electrolytic cell;
a circulation pump adapted to pump water from a main body of water to said inlet and through said at least one electrolytic cell;
said outlet of said at least one electrolytic cell being in fluid communication with a return line that returns water to said main body of water;
an acid infusion means adapted to infuse a pH-reducing agent disposed in selective fluid communication with said at least one electrolytic cell;
a timer in electrical communication with said circulation pump, said timer adapted to start and stop said circulation pump at predetermined times;
a control means, said timer being part of said control means and said control means being in continuous, substantially uninterrupted electrical communication with electrical power;
said control means including software calculates the optimal cycle times based on the operating schedule of said circulation pump.
